(19) United States
(12) Patent Application Publication
(10) Pub. No.: US 2004/0144257 A1
(43) Pub. Date: Jul. 29, 2004

(54) Temperature compensation in an electronic circuit toaster

(76) Inventor: Claude Battu, Le Syndicat (FR)

Correspondence Address: BROWDY AND NEIMARK, P.L.L.C., 624 NINTH STREET, NW, SUITE 300, WASHINGTON, DC, 20001-5303, US

(21) Appl. No.: 10/478,841

(22) PCT Filed: May 22, 2002
(86) PCT No.: PCT/FR02/01713

(30) Foreign Application Priority Data
May 23, 2001 (FR) 01/06832

(51) Int. Cl. A47J 37/08; A23L 1/00

(52) U.S. Cl. 99/327; 99/331; 99/385

(57) ABSTRACT

The invention concerns a method for determining the thermal condition of a heat chamber of a toaster wherein extend grilling and/or heating means, said toaster having in particular means for triggering a grilling or heating cycle and means for adjusting the desired degree of grilling. The invention is characterised in that it consists in: measuring, at two different times (t1) and (t2) after triggering the grilling or heating cycle, respective values (A1) then (A2) of a thermally variable capacitor (C) or a quantity representative of said value, said capacitor (C) being subjected to the influence of the grilling and/or heating means; calculating the ratio (r) of the two measurements (A1, A2) produced so as to determine the thermal condition of the heat chamber at the triggering time of the grilling or heating cycle.

The present invention relates to the field of toasters and particularly those controlled by a microcontroller.

The invention concerns more particularly compensation of the cooking time of bread according to the initial temperature of the heating chamber. This compensation is already known in toasters controlled by a microcontroller, where the range of toasting temperatures is pre-selected on the basis of values stored in memory in the microcontroller, these values being adjusted during use, as a function of the existing temperature, at the start of the toasting cycle, at the interior of the toasting chamber.

Determination of the temperature within the heating chamber can be carried out by measurement of the times separating two successive uses of the toaster, as in the document U.S. Pat. No. 5,128,521. This solution, however, does not permit a real idea of the temperature at the interior of the heating chamber to be obtained. In addition, physical disconnection of the toaster erases all data relative to this parameter.

In the document FR 2 769 456, it is proposed to furnish permanent information on the temperature at the interior of the heating chamber with the aid of a temperature sensor constituted by a thermistor, permitting a precise determination of the temperature by the large variation of the resistance value presented by this element. This electric parameter can be integrated in different ways in a measuring channel in order to determine its value. The temperature is measured at the very interior of the cooking chamber or by its image, reproduced on the control electronics. The resulting compensation function is determined on the basis of the position of the selector determining the degree of toasting of the bread and according to the value of resistance of the thermistor, said function being stored in the internal memory of the microcontroller.

However, the use of a thermistor presents a certain cost. One of the objects of the present invention is in particular to reduce the cost of such a temperature compensation function.

The present invention is achieved by a process for determining the thermal state of a heating chamber of a toaster at the interior of which extend means for toasting and/or reheating, said toaster having particularly means for starting a toasting or heating cycle of bread as well as means for regulating the degree of toasting desired, characterized in the it consists:

in measuring, at two different moments after the start of a toasting or reheating cycle, the respective values of a thermally variable capacitor or a magnitude represented by this value, said capacitor being subjected to the influence of the toasting and/or reheating means,

in calculating the ratio of the two measurements obtained in order to determine the thermal state of the heating chamber at the moment of starting said toasting or reheating cycle.

The use of a capacitor having a high sensitivity to the surrounding temperature permits, by placing it, either in the cooking enclosure or in proximity to this latter, or in the nearby environment of a power supply resistance to simulate a thermal image, its use as a temperature sensor. The principle rests on a comparison of the value of the capacitor or a magnitude representative of this value at two different moments of the heating cycle, which permits one to be free of the actual value of the capacitor, since there is performed a relative measurement.

Advantageously, the first moment of measuring the value of the capacitor is realized with a delay of less than 15 seconds after start of a toasting or reheating cycle of the bread, which permits an independent measurement of the heating cycle in progress.

In order to best determine the initial thermal state of the heating chamber, the second moment of measurement is effected at least 10 seconds after the first in order to thus assure that the capacitor truly undergoes the thermal influence of the heating cycle in progress, the proximity of this measurement to the first determining, by comparison, the initial thermal conditions of the heating chamber.

According to one of the possible implementations of the invention, the measurement consists in determining the time of charging of said capacitor through a thermally stable resistance, this charging time then being a function only of the value of the capacitor. This measurement permits the use of a low end, and thus inexpensive, microcontroller, to the extent where a simple counter to effectuate a time measurement is necessary.

Advantageously, the resistance used is the potentiometer for regulating the degree of toasting or reheating of the bread, permitting a combination of the the initial thermal state of the heating chamber with the same subassembly.

The present invention also concerns a control circuit for the toaster, having particularly an electronic card in which is implanted a potentiometer for regulating the degree of toasting or of reheating of the bread, the value of which determines an initial toasting or reheating time, a microcontroller permitting direction of the supply of current to the heating elements of the toaster, maintenance of the rack in the lowered toasting position, depending on the time necessary to attain the desired degree of toasting or reheating, said microcontroller having available digitized tables of the initial bread toasting or reheating times, as well as means permitting a determination of the actual duration for toasting or reheating of the bread and the power to be generated by the heating means as a function of the initial thermal state of the heating chamber, characterized in that this control circuit makes use of, in order to determine the real duration for toasting or reheating (Tr) of the bread, a process for determining the thermal state of said heating chamber as previously described.

According to a preferred embodiment, the ratio of the two measurements determines the value of the compensation c used for the definition of the real toasting or reheating time (Tr) as a function of the toasting time (Tf) initially fixed by the potentiometer for regulating the degree of toasting according to the law:

Tr=Tf(1−c).

According to one of the possible embodiments of the present invention, the potentiometer for regulating the degree of toasting or reheating of the bread as well as the capacitor having a large thermal variation constitute a circuit of the R-C type, the microcontroller measuring the time of charging of the capacitor at the two moments t1 and t2, no only across the entire value of the potentiometer P, but equally across the fraction selected for regulating the degree of toasting or reheating.

By this specified unique arrangement and the measurements performed by the microcontroller, it is possible, not only to determine the desired degree of toasting or reheating, by the compared measurement of the charging time of the capacitor through the total resistance of the potentiometer then, successively, through the fraction corresponding to the selected degree of toasting or reheating, but also the determination of the evolution of the value of capacitor reflects the thermal evolution of the heating chamber by the measurements, with the same resistance value, of the capacitor at two distinct moments.

The arrangement is thus simplified to a R-C circuit, the microcontroller permitting achievement of the series of measurements in a simple and inexpensive manner.

The present invention equally relates to a toaster, having a housing, at least one slot for the introduction of bread, a toast rack, associated with a return spring, and movable between at least one toasting position and a bread discharge position in a heating chamber at the interior of which extend toasting and/or reheating means forming sources of infrared radiation, means for starting toasting of the bread, an electromagnet for maintaining the rack in a toasting position, a microcontroller associated with an electronic card, said electronic card having a control circuit as described previously.

Advantageously, the microcontroller is provided with an internal time counter able to generate a signal permitting freeing of the rack and halting of the supply of current to the heating means when the duration of the present toasting cycle has reached the real toasting duration, said duration of the present toasting cycle being determined with the aid of the time counter of the microcontroller.

Utilization of the microcontroller to direct the supply of current to the heating elements, as well as the management of the electromagnet avoids the utilization of costly analog circuits and simplifies the design of the electronic card. Utilization of the internal time counter of the microcontroller avoids a specific component for this function.

Advantageously, the microcontroller, during a toasting cycle, is capable of measuring, at regular time intervals, the state of the selectors in order to recalculate the toasting duration (Tf, Tr) when a modification, by the user, of the parameters influencing this toasting duration takes place. This characteristic permits the user to be able to modify at any moment the position of the potentiometer for regulating the duration of toasting or reheating and to note a taking into account of this modification on the effective toasting or reheating duration.

This equally permits a determination of the initial thermal state of the heating chamber with a greater precision.

Other particularities and advantages of the present invention will appear and become more apparent in detail from a reading of the description provided herebelow presenting an embodiment of the present invention, with reference to the attached figures, given by way of non-limiting examples, among which:

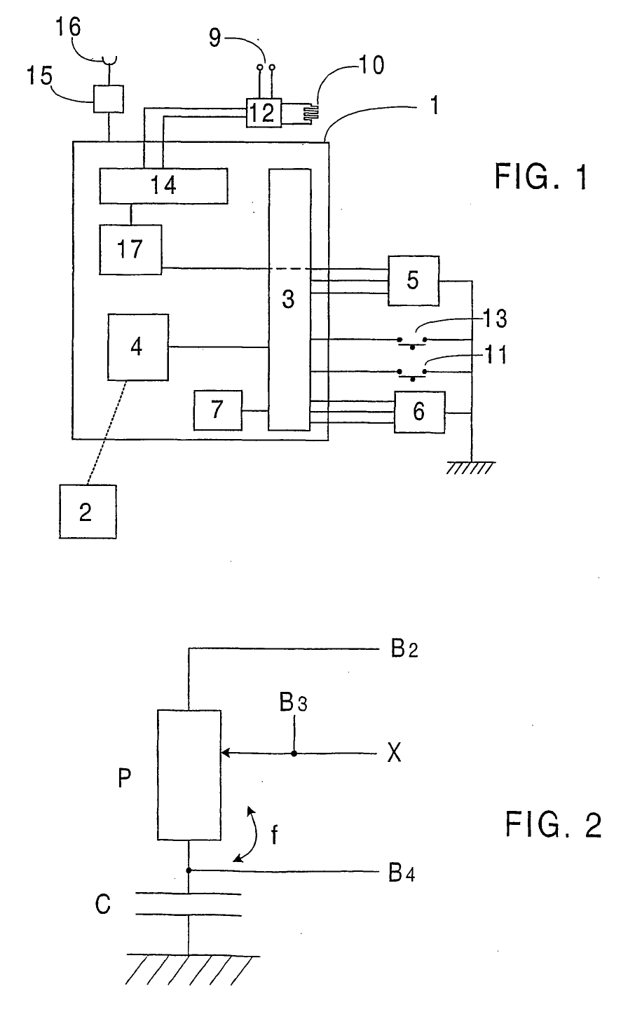

FIG. 1 represents the architecture and relations of a microcontroller used according to an example of implementation of the invention,

FIG. 2 presents the general principle of the proposed process,

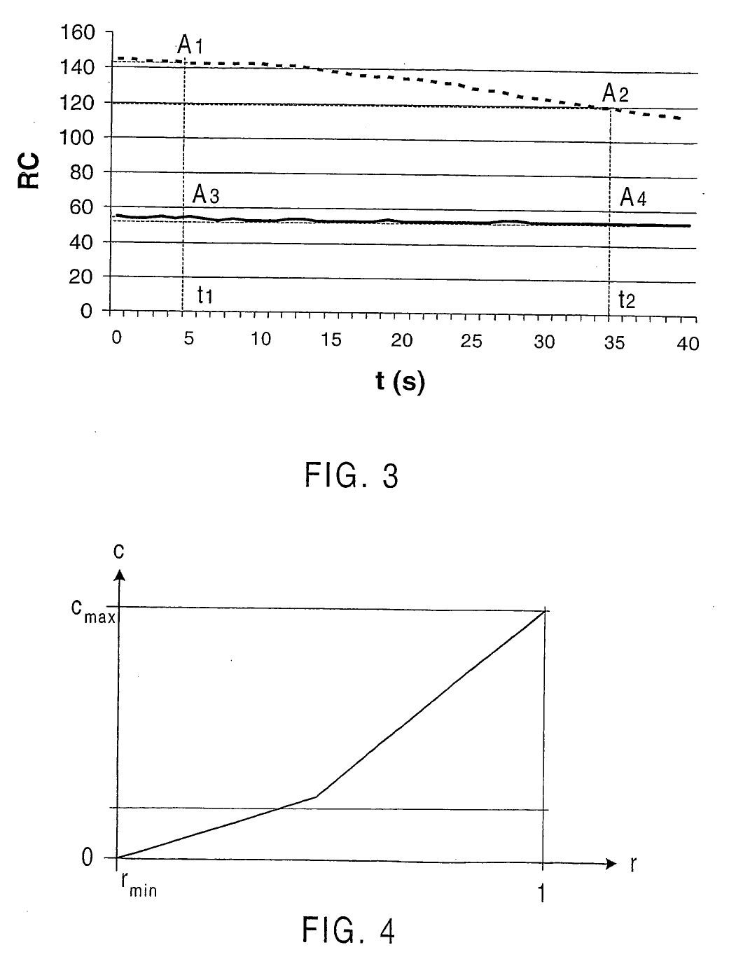

FIG. 3 is a graph illustrating the measurements effected according to the proposed process,

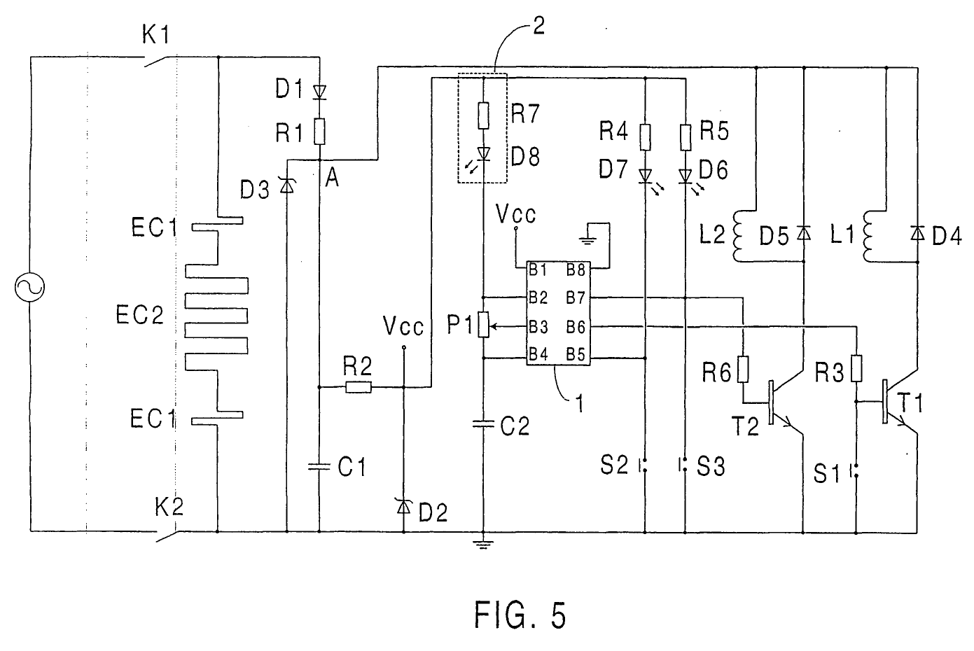

FIG. 4 is a graph illustrating the relation between the measurements effectuated and the compensation function,

FIG. 5 shows an example of the structure of a control circuit for a toaster according to the present invention.

According to FIG. 1, the architecture of the control intended to equip a toaster, not shown, includes, shown schematically, a microcontroller 1, equipped with an internal time counter 7 and a delay cell 3.

On FIG. 1 are equally represented, at the input of the microcontroller, a cycle halting switch 11 permitting at any moment interruption of the toasting cycle in progress and ejection of the bread, as well as a starting switch 13, starting the toasting cycle, which can be a button actuated by the user or simply a switch triggered by the toast rack when it is found in the lowered position.

According to the proposed example, a cell 14 for amplification of the outputs permits a control of a block of cycle relays 12 for the heating elements 10. An electromagnet 15, responsible for maintaining bread rack 16 in the lower position, can equally be connected to the amplification cell or even, as shown in the example, be controlled directly by the microcontroller 1.

The electric supply is represented at 9 and permits, particularly, through the intermediary of relay block 12 the supply of at least one of the heating elements 10 of the toaster.

The toaster can have available several functions accessible to the user, via selector 5, determining a particular mode of operation, such as heating, defrosting, a rapid function, a mode specific for cooking bread of the baguette type, or even doughnuts of the bagel type, where toasting of the bread is effective or accentuated on a single face of said bread.

Function block 6 combines at one time this choice of different functions available on the toaster, as well as means for determining the thermal state of the heating chamber, such as will be presented below.

According to the selected function as well as the type of toaster, the heating power can be caused to vary, by the intermediary of a cell 17 controlling the block of cycle relays, the cycling relation being modified according to the choice of the user.

Regulation of the degree of toasting of the bread is obtained by a potentiometer P, with reference to FIG. 2, actuated by the user. In the proposed example, the indication furnished by potentiometer P is analog. This indication is rendered digital to be compatible with the microcontroller utilized which does not have an integrated analog/digital conversion function. The invention covers, however, the use of a microcontroller having this integrated analog/digital conversion function, the choice of not using such components being essentially connected to their present cost.

The electrical structure of FIG. 2, which is thus integrated into functional block 6 of FIG. 1, is used to achieve the analog/digital conversion. On this figure, the notation B2, B3, B4 correspond to certain pins of the microcontroller such as appear on the component of FIG. 5, pins that are the inlet-outlet ports to which are connected the electrical connectors presented. The measurement principle is substantially the same as that exposed in the document FR 2 769 456, and is only one of the possible variants to effectuate this conversion, given by way of illustrative example.

Thus, determination of the position X of the wiper of the potentiometer P is based on the charging time of a capacitor C through this resistance made variable by the regulation effectuated by the user of the degree of toasting and/or reheating desired for the bread.

The following sequences, referring to FIG. 2, are thus generated by the microcontroller:

place ports B₂ and B₃ at high impedance, which corresponds to a disconnection, then place port B₄ at a low voltage in order to discharge the capacitor C,

place ports B₃ and B₄ at high impedance then place port B₂ at high voltage in order to charge the capacitor C through the resistance P up to the high state of port B4. The charging time is denoted T1P,

reinitialization of the system by placing ports B₂, B₃, at high impedance and place port B₄ at a low voltage state in order to discharge the capacitor C,

place B₃ at the high voltage state and charge C through a fraction of P, denoted f, up to the high voltage state of port B₄. The charging time is denoted T2P.

The two chargings being effectuated on the same resistance and the same capacitor, the time ratio T2P/T1P is equal to the fraction f, between 0 and 1. This method permits freedom from the dispersion encountered in potentiometer resistance values, of the order of 20%.

Time counter 7 of the microcontroller permits a determination of the two times T1P and T2P between the start of charging of the capacitor C and the passage to state 1 of port B₄ and thus the fraction f that is representative of the position of the wiper.

Preferably, the potentiometer P used is a potentiometer with 250° of electric angle. The value of f is stored in a module of memory 4.

The wiper position thus determines the “cold” toasting time Tf of the toaster, which are the times applied when the toaster has completely cooled from a previous use. These toasting times depend on the type of toaster considered as well as the different parameters such as the power of the heating elements, the voltage used, the different toasting and reheating functions available, or even the eating habits of the potential users.

All of this information as well as the presently active functions and the parameters available on the toaster are stored in a memory 4 and represent data permitting a determination of the “cold” toasting time Tf.

Storage of the data in memory, adjustment and more generally programming of the electronic card and the associated tests are advantageously carried out by an IR link at high data rate symbolized by function block 2 of FIG. 1, which permits them to be carried out in in-situ on the assembly line for example.

Moreover, these components necessary for the preceding operations can remain on the electronic card to then be used in order to transmit to a remote location information relating to testing, calibration, malfunctions, toasting time data etc . . . They can equally be used to produce different ranges of products, notably by the modification of certain parameters, and this in a simple and economical manner, while avoiding having to produce one electronic control card per product family.

The particularity of the present invention resides in the taking into account of the temperature existing at the interior of the toaster, by utilization of a capacitor having a relatively large dependence on temperature, and which thus plays the role of temperature sensor, by being either placed in the cooking enclosure, or in proximity.

According to the proposed example, said capacitor utilized as a temperature sensor is the capacitor C previously presented and inserted in the circuit for measuring the value of the potentiometer P for regulating the desired degree of toasting. The capacitor is preferably a ceramic capacitor having a low selling price.

The substantial thermal variation of the capacitor C does not adversely affect the determination of the fraction f to the extent that the determination of the times T1P and T2P is performed within a very short time period (several ms) during which the value of the capacitor C does not have the time to change significantly. Moreover, the charging times T1P and T2P are determined shortly after start of a heating cycle. Now, the inertia of the heating elements added to that of the response to a temperature change of the capacitor C leads to this latter reacting only slightly during the first 10 seconds of a heating cycle, which is largely sufficient to determine the fraction f of the regulation of the degree of toasting or of reheating of the bread.

Although it is economically more desirable to combine the two functions of determination of the degree of toasting or of reheating and of the thermal state of the heating chamber of the toaster on the same circuit R-C, the present invention equally covers the case where two distinct circuits are utilized, one with the potentiometer and a thermally stable capacitor, the other with a capacitor having a substantial thermal variation and a fixed and stable resistance.

The principle of the determination of the initial thermal state of the heating chamber is thus to measure the charging of the capacitor through the total value of the potentiometer P, at two different moments, one very shortly after the start of a toasting and/or reheating cycle, and the other after a passage of time sufficient for the capacitor to have been noticeably influenced by the heat released by the heating elements, or by a thermal image with the aid of the supply resistance.

As mentioned previously, the measurement T1P corresponds to the charging time of the capacitor through the potentiometer P. In effectuating this measurement at two moments previously mentioned, it is possible to determine the thermal state of the heating chamber at the start of the toasting and/or reheating cycle.

FIG. 3 shows in effect the evolution in arbitrary values of the charging time of capacitor C through the potentiometer P, as a function of time, a toasting cycle having been started at the time t=0s.

The curve in dotted lines is representative of a start of the toasting cycle with a heating chamber that is initially cold while the curve in solid lines is obtained after several toasting cycles have been carried out.

It is quite visible that after a certain number of consecutive cycles have been carried out, the toasting chamber becomes stabilized at a certain temperature, leading to little or no evolution, for a new toasting cycle, of the charging time of the capacitor C through the potentiometer P.

Thus, by carrying out two measurements at the moments t1 and t2 such as previously defined, the values obtained for the charging time of the capacitor are that much more different when the heating chamber was initially cold at the start of the cycle. The ratio between the two measurements thus represents the thermal state which can be refined with the actual charging time value, this latter being that much greater when the chamber is cold.

In the proposed example, the values obtained A1 and A2 are elevated and the ratio of the two values A2/A1 denoted r hereafter, is small, which translates into an initially cold chamber, while the values A3 and A4 are small and close to one another, which translates into a heating chamber that is initially at an elevated temperature.

One can note, moreover, that the variation of charging time of the capacitor, for an initially cold chamber, is small during around the first 15 seconds, then decreases more rapidly up to the end of the toasting cycle, a time interval during which the variation is small being able to be explained by the response time of the capacitor linked particularly to thermal inertia. This response time is thus variable depending on the embodiment of the heating chambers, the power used, the position of the capacitor,

In general, there is thus performed a double series of measurements, to determine, on the one hand, the function f relative to the degree of toasting desired, and on the other hand the initial thermal state of the heating chamber, which can be quantified, as previously explained.

This quantification of the initial thermal state of the heating chamber is used to supply a correction to the time Tf applicable when the heating chamber is cold, by the intermediary of a compensation function c which can take several diverse formulations, such as is known in the prior art by the measurement of the temperature of the heating chamber. According to the present implementation, the function c is between 0 and 1 and permits a determination of the real toasting time Tr according to the formula:

Tr=Tf(1−c)

The correspondence between the value of c and the ratio r of the charging time at the two successive moments depends on the configuration of the different heating chambers, the power of the heating elements. In effect, the measurement is not an instantaneous measurement but flows from two measurements at different times. It is thus necessary to take into account the dynamic evolution of the heating chamber to determine the initial thermal state of said chamber.

FIG. 4 shows an example of the relation between the value of the ratio r and the value of the compensation function c. The value of r varies between rₘᵢₙ and 1, while the compensation function c varies between 0 and cₘₐₓ. Preferably, the curve permitting obtaining the values of c corresponding to the ratio r is represented by two linear portions, the slope of which is greater for high r values, where the need for compensation is substantial since the cooking chamber initially has a high temperature. Other types of relation between the values of c and of r can be envisioned without departing from the framework of the present invention and can particularly be influenced by the available parameters and functions.

The implementation of the compensation function will not be described in detail in the present description. It is in effect known per se in different documents and notably largely commented on in the document FR 2 769 456.

FIG. 5 shows an electronic card that can be utilized for implementation of the invention as well as the implantation of the different components.

Thus, the power supply is realized starting from the mains voltage supply brought up to switches K1, K2 connected to the load represented by two lateral heating elements EC1 and a central heating element EC2, the toaster under consideration having two heating chambers. By the intermediary of the diode D1, connected in series with the resistance R1, a voltage of 60V is present at point A, when switches K1, K2 are closed. Diode D3 and capacitor C1 permit respectively to limit and filter the signal of this supply voltage.

Microcontroller 1 used has 8 inlet/outlet ports denoted B1 to B8. Ports B1 and B8 serve to supply it with power. Ports B2, B3 and B4 have already been introduced. Resistance R7 and diode D8 in series symbolize the IR link with a high rate of parameter setting and of implementation of the card. This link is supplied by the arrangement Vcc/R2/D2 which also supplies diode D7 via resistance R4. The second end of diode D7 is connected to port B5 of the microcontroller as well as to a switch S2. This arrangement corresponds to a particular mode of operation (reheating, defrosting, “bagel” function, . . . )

An identical arrangement is proposed with resistance R5 in series with diode D6, itself connected to switch S3 and to port B7 of the microcontroller, thus permitting creation of a second supplementary function. In the present case, this function corresponds to a “bagel” function where one face of the food to be toasted is heated more than the other face. To do this, a relay L2 is controlled by a transistor T2 and guided by switch S3 connected to the base of transistor T2 through a resistance R6. The emitter of this transistor is connected to ground, while its collector is connected to a terminal of relay L2. The other terminal of this relay is coupled to point A. In the arrangement such as presented, the relay permits turning off of the power supply for the central element when the “bagel” function has been selected. Other variants can equally be implemented, as for example the achievement of power supply cycles only on the central element, or even on the lateral elements or the totality of the heating elements, in order to achieve keeping bread warm, or to achieve bread of the melba toast type.

Finally, port B6 permits guiding the electromagnet represented by winding L1, through resistance R3, transistor T1 and cycle switch S1, in an arrangement identical to that of relay L2.**

The electromagnet will preferably be controlled by pulses of voltage of. 50 to 100V depending-on the type of electromagnet chosen, at a frequency of 20 KHz, the width of the pulses being of the order of 8 μs. This arrangement permits reducing the winding of the electromagnet by the high voltage present, while reducing the energy dissipated.

The operation of a toast according to the present invention can be described by the following sequences:

(1) the user regulates the degree of toasting or cooking desired with the aid of the wiper of potentiometer P.

(2) when the bread rack is brought to the lowered position by the user, the microcontroller then initiates a general power supply of the electronic card and of the heating elements. In the same time, a counter initialized to 0 is started. The microcontroller then effectuates each second, the measurements T1P and T2P

(3) after a delay of the order of 10s after initiation of the cycle, the microcontroller determines the value f of the signal generated on the pin B₃ of the microcontroller, from the measurements of T1P and T2P and stores the value T1P (total value taken on the potentiometer). Depending on the complexity of the toaster and the mode of operation selected when such a possibility is offered, the microcontroller determines the toasting or cooking values according to the value of f, as well as the general curve of the compensation function, and particularly the maximum value cₘₐₓ.

(4) around 30s after start of a toasting and/or reheating cycle, the microcontroller determines and stores again the value T1P and effectuates the ratio with the value initially found in step (3). This ratio is then an indication of the thermal state of the heating chamber at the start of the heating cycle. With the aid of the procedure described previously, the correction function c is calculated. The real toasting time Tr is then the cold toasting time Tf modified by the compensation function c.

(5) each second, this counter is incremented. This internal is defined arbitrarily as one second. It can be selected to have another value without departing from the framework of the present invention.

When the counter counts to a value greater than the determined toasting time Tr, the toasting cycle is halted, the microcontroller shutting off the supply of power for the winding of the electromagnet retaining the toast rack which can then move up to a position for discharging the bread, while turning off the power supply of the heating elements and of the microcontroller itself.

In a variant of construction, during a toasting cycle, the parameters selected by the user (degree of toasting and choice of function), influencing the toasting time, are recalculated each second by the microcontroller, and a new toasting duration is possibly calculated when these parameters have been modified. This possible new duration replaces the duration initially provided and this, even though the toasting cycle has started. Thus, even belated modifications by the user, of the toasting parameters are taken into consideration for calculation of the toasting time of the cycle in progress, permitting the desires of the user to be respected to the maximum.

In order to be able to continually supply power to the electromagnet by the pulses mentioned previously, the microcontroller program is of the “grafcet” type and permits a multitasking function where the microcontroller controls at regular intervals the pulses for maintaining the electromagnet, while effecting between times the above-mentioned operations.

The present invention is not limited to the single example of construction proposed, but equally covers variants of construction linked to the technology used, particularly in the choice of the microcontroller, this latter being able to be equipped with an integrated function of analog/digital conversion.

Moreover, the capacitor utilized can be disposed outside the heating chamber, subjected indirectly to the influence of the heating elements through the intermediary of a so-called “image” temperature, where a component undergoes a heating in correspondence with the heating of the heating chamber. This can be a resistance placed in the power supply circuit of the heating elements and which, by the Joule effect, heats in accordance with the current drawn by said heating elements, the capacitor then being placed in immediate proximity to this control resistance.

Moreover, according to the type of toaster considered, the two moments of measurement can be modified, particularly the second, if it is initially longer than the shortest toasting time available on the toaster. It is however preferable to postpone to the maximum the moments of the second measurement in order to increase the precision on the values compared.

It is to be noted that the control steps for the supply of power and for turning off the heating means as well as for the lifting of the bread rack can be achieved by means that are conventional and currently employed in the implementation of such appliances, without recourse to a microcontroller control without departing from the framework of the present invention.

However, the utilization of a microcontroller to direct the totality of function of a toaster permits an easy adaptation of new function and/or extending the existing ones, simply by a new programming of the microcontroller.

1. Process for determining the thermal state of a heating chamber of a toaster at the interior of which extend means for toasting and/or reheating, said toaster having particularly means for starting a toasting or heating cycle of bread as well as means for regulating the degree of toasting desired, characterized in that it consists:
in measuring, at two different moments (t1) and (t2) after the start of a toasting or reheating cycle, the respective values (A1) then (A2) of a thermally variable capacitor (C) or a magnitude representative of this value, said capacitor (C) being subjected to the influence of the toasting and/or reheating means, the second moment of measurement (t2) being achieved at least 10 seconds after the first,
in calculating the ratio (r) of the two measurements (A1, A2) obtained in order to determine the thermal state of the heating chamber at the moment of starting said toasting or reheating cycle.

2. Process for determining the thermal state of a heating chamber according to the preceding claim, characterized in that the first moment (t1) of measuring the value of the capacitor is achieved with a delay of less than 15 seconds after start of a bread toasting or reheating cycle.

3. Process for determining the thermal state of a heating chamber according to one of the preceding claims, characterized in that the measurement consists in determining the time of charging (T1p, T2P) of said capacitor (C) through a thermally stable resistance.

4. Process for determining the thermal state of a heating chamber according to the preceding claim, characterized in that the resistance used is the potentiometer (P) for regulating the degree of toasting or reheating of the bread.

5. Control circuit for a toaster, having particularly an electronic card in which is implanted a potentiometer (P) for regulating the degree of toasting or of reheating of the bread, the value of which determines an initial toasting or reheating time (Tf), a microcontroller (1) permitting direction of the supply of current to the heating elements (10) of the toaster, maintenance of the rack in the lowered toasting position, depending on the time necessary to attain the desired degree of toasting or reheating, said microcontroller (1) having available digitized tables of the initial bread toasting or reheating times (Tf), as well as means permitting a determination of the actual duration (Tr) for toasting or reheating of the bread and the power to be generated at the level of the heating means as a function of the initial thermal state of the heating chamber, characterized in that this control circuit makes use of, in order to determine the actual duration (Tr) for toasting or reheating of the bread, a process for determining the thermal state of said heating chamber according to one of claims 1 to 4.

6. Control circuit according to the preceding claim, characterized in that it uses the ratio (r) of the two measurements (A1), (A2) to determine the value of the compensation (c) used for the definition of the actual reheating time (Tr) as a function of the toasting time (Tf) initially fixed by the potentiometer for regulating the degree of toasting according to the law:
Tr=Tf(1−c).

7. Control circuit according to the preceding claim, characterized in that the potentiometer (P) for regulating the degree of toasting or reheating of the bread as well as the capacitor (C) having a large thermal variation constitute a circuit of the R-C type, the microcontroller (1) measuring the time (T1P, T2P) of charging of the capacitor (C) at the two moments (t1) and (t2), not only across the total value of the potentiometer (P), but equally across the fraction (f) selected for regulating the degree of toasting or reheating.

8. Toaster, having a housing, at least one slot for the introduction of bread, a toast rack, associated with a return spring, and movable between at least one toasting position and a bread discharge position in a heating chamber at the interior of which extend toasting and/or reheating means (10) forming sources of infrared radiation, means for starting toasting of the bread, an electromagnet for maintaining the rack in a toasting position, a microcontroller (1) associated with an electronic card, said electronic card having a control circuit according to one of claims 5 to 7.

9. Toaster according to the preceding claim, characterized in that the microcontroller (1) is provided with an internal time counter (7) able to generate a signal permitting freeing of the rack and halting of the supply of current to the heating means (10) when the duration of the present toasting cycle has reached the actual toasting duration (Tr), said duration of the present toasting cycle being determined with the aid of the time counter (7) of the microcontroller (1).

10. Toaster according to one of claims 8 or 9, characterized in that the microcontroller (1), during a toasting cycle, is capable of measuring, at regular time intervals, the state of the selectors (5, 6) in order to recalculate the toasting duration (Tf, Tr) when a modification, by the user, of the parameters influencing this toasting duration takes place.
